(19) United States
(12) Patent Application Publication
(10) Pub. No.: US 2007/0217527 A1
(43) Pub. Date: Sep. 20, 2007

(54) Method and system for determining channel response in a block transmission system

(75) Inventors: Sriram Rajagopal, Santa Clara, CA (US); Parikshith Sreebhasvam, Santa Clara, CA (US); Krishnamurthy Giridhar, Santa Clara, CA (US)

Correspondence Address: Beceem Communications Inc, 1st Floor, 3960 Freedom Circle, Santa Clara, CA, 95054, US

(73) Assignee: Beceem Communications, Inc.

(21) Appl. No.: 11/481,616

(22) Filed: Jul. 6, 2006

(30) Foreign Application Priority Data
Mar. 20, 2006 (IN) 388/MUM/2006

(51) Int. Cl. H04K 1/10; H04L 27/06

(52) U.S. Cl. 375/260; 375/340

(57) ABSTRACT

A method and system for determining channel response is provided. The method for determining a channel frequency response (CFR) in a block transmission system comprises performing an N′ point Fast Fourier Transformation (FFT), where N′ is a function of N and K, and N is approximately equal to the number of sub-carriers in a block, and K depends on the coherence bandwidth of the channel corresponding to the block.

### RELATED APPLICATION DATA

This application claims priority to and incorporates by reference India provisional application serial number 388/MUM/2006, filed on Mar. 20, 2006, titled “Method And System For Determining Channel Response In A Block Transmission System”

### BACKGROUND

The invention generally relates to a block transmission system. More specifically, the invention relates to a method and system for determining channel response in a block transmission system.

In block transmission systems, channel estimation involves computing one of Fast Fourier Transformation (FFT) and Inverse Fast Fourier Transformation (IFFT) of the time domain samples and frequency domain samples, respectively. However, the cost of such FFT/IFFT based channel estimation can be significant for large FFT/IFFT sizes.

There is therefore a need for a method and system that performs computationally efficient channel estimation in a block transmission system.

### SUMMARY

An embodiment provides a method and system for computationally efficient estimation of channel response in a block transmission system.

A method and system for determining a channel response in a block transmission is provided. In an embodiment, the method for determining a channel frequency response (CFR) in a block transmission system comprises performing an N′ point Fast Fourier Transformation (FFT), where N′ is a function of N and K, and N is approximately equal to the number of sub-carriers in a block, and K depends on the coherence bandwidth of the channel corresponding to the block. In another embodiment, the method for determining a channel impulse response (CIR) in a block transmission system comprises performing an N″ point Inverse Fast Fourier Transformation (IFFT), where N″ is a function of N and P, and N is approximately equal to the number of sub-carriers in a block, and P is approximately equal to the pilot sub-carrier spacing.

### BRIEF DESCRIPTION OF DRAWINGS

FIG. 1 is a flowchart for determining a channel frequency response (CFR) of a plurality of data symbols in a block transmission system, in accordance with an embodiment.

FIG. 2 is a flowchart for determining a CFR of a plurality of data symbols in a block transmission system, in accordance with another embodiment.

FIG. 3 is a flowchart for determining a channel impulse response (CIR) of a plurality of data symbol in a block transmission system, in accordance with an embodiment.

FIG. 4 is a block diagram of a receiver of a block transmission system, in accordance with an embodiment.

### DETAILED DESCRIPTION OF THE DRAWINGS

Embodiments described below provide a method and system for determining a channel response in a block transmission system. In an embodiment, a channel frequency response (CFR) is estimated. In another embodiment, a channel impulse response (CIR) is estimated. Examples of the block transmission system include orthogonal frequency-division multiplexing (OFDM), multi-carrier code division multiple access (MC-CDMA) and discrete multi-tone (DMT) but can include other types of systems.

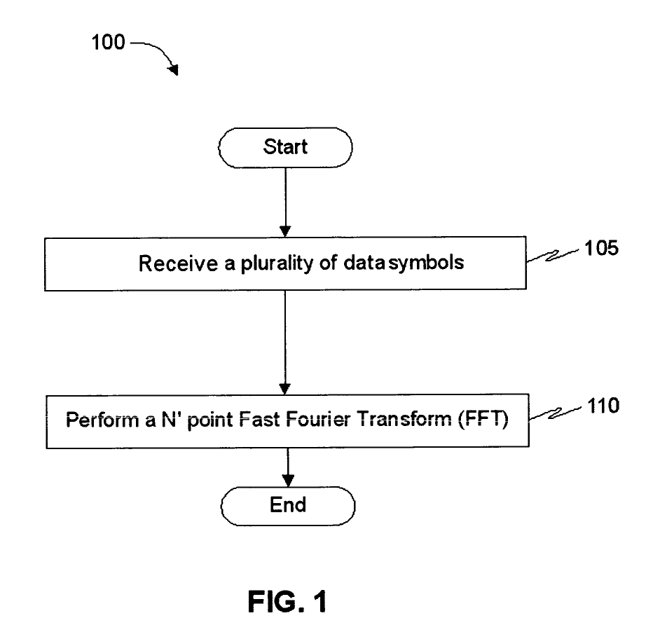

FIG. 1 is a flowchart for determining a CFR of a plurality of data symbols in a block transmission system, in accordance with an embodiment. At 105, the plurality of data symbols is received by a receiver. At 110, the CFR of each data symbol in the block transmission system is determined by performing an N′ point Fast Fourier Transformation (FFT).

In various embodiments, N′ is a function of N and K, where N is approximately equal to the number of sub-carriers in a block, and K depends on the coherence bandwidth of the channel corresponding to the block. In an embodiment, N′ is approximately equal to a ratio of N and K. In an example embodiment, N′ is equal to N/K.

In an example embodiment, an N point FFT is shown at equation (1):

$$X [ i ] = {\sum }_{n = 0}^{N - 1} x [ n ] {e}^{- j \frac{2 π in}{N}} - \qquad ( 1 )$$

where

### N represents number of sub-carriers in a block;

n represents the time index (for example, OFDM sample index); and
i represents the sub-carrier index.
If N′=N/K, the N′ point FFT is as follows:

$$X [ Ki ] = {\sum }_{m = 0}^{m = K - 1} {e}^{- j2π im} {\sum }_{n = 0}^{\frac{N}{K} - 1} x [ n + m \frac{N}{K} ] {e}^{- j \frac{2 π in}{\frac{N}{K}}} - \qquad ( 2 )$$

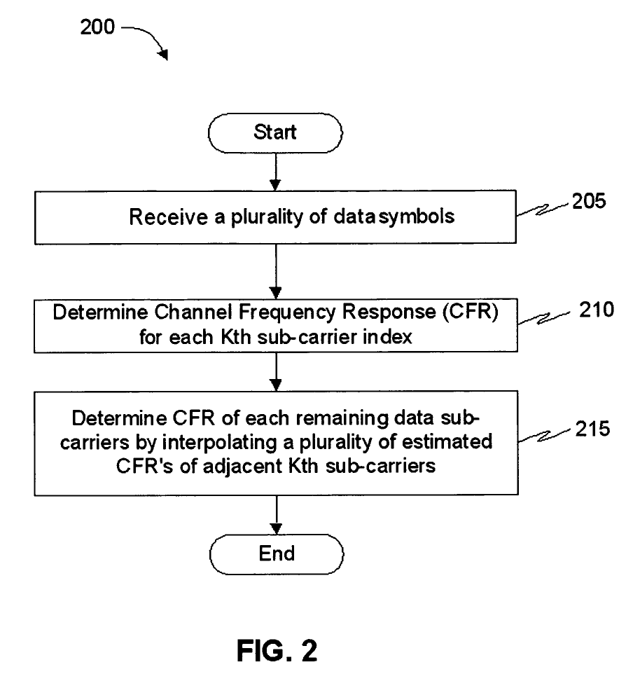

In an embodiment, K is an integral power of two but is not so limited. Further, a CFR is estimated for each Kth sub-carrier index. Since N/K consecutive values of x[n] are considered, only one value of the outer summation is used. Therefore, the computation is reduced by a factor of K. This is further explained below with reference to FIG. 2.

FIG. 2 is a flowchart for determining a CFR of a plurality of data symbol in a block transmission system, in accordance with another embodiment. At 205, the plurality of data symbols is received by a receiver. Thereafter, at 210, the CFR for each Kth sub-carrier index of each data symbol is determined using N′ point FFT.

At 215, the CFR corresponding to each remaining data sub-carrier is determined by interpolating a plurality of CFRs corresponding to adjacent Kth sub-carriers. As a result, the interpolation is not performed for remaining sub-carriers on which, for example, pilot tones are transmitted. In an embodiment, linear interpolation is performed to determine the CFR corresponding to each remaining data sub-carrier. In various embodiments, the sub-carrier index of each remaining data sub-carrier is unequal to an integral multiple of K.

Also, the interpolation order may be modified to handle band-edge effects. For example, near the left or right band-edges, the interpolation order can be reduced or spline interpolation can be applied on the left or right band-edges. This further improves channel estimation quality of an embodiment.

In an embodiment, the interpolation is carried out for remaining data sub-carriers on which data is transmitted for a corresponding user. For example, data for a user is transmitted on nearly 10% of the total sub-carriers within a symbol. As a result, this translates into considerable computational savings.

In an embodiment, K can further depend on the complexity of the interpolation. As such, there is a tradeoff between the value of K chosen and the complexity of interpolation. For example, if K is increased (i.e., fewer frequency domain samples), a better interpolation scheme is chosen (i.e., more complex interpolation scheme is chosen) to maintain the quality of channel estimate.

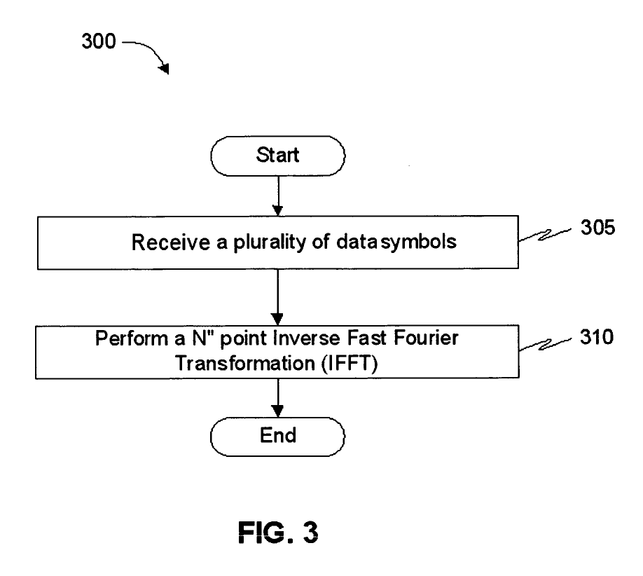

FIG. 3 is a flowchart for determining a CIR of a plurality of data symbols in a block transmission system, in accordance with an embodiment. At 305, the plurality of data symbols is received by a receiver. At 310, the CIR of each data symbol in a block transmission system is determined by performing an N″ point Inverse Fast Fourier Transformation (IFFT).

In various embodiments, N″ is a function of N and P, where N is approximately equal to the number of sub-carriers in a block, and P is approximately equal to the pilot sub-carrier spacing. In an embodiment, N″ is equal to ratio of N and Q, where Q is a common divisor of N and P. In an example embodiment, N″ is equal to N/Q. In an embodiment, Q is an integral power of two but is not so limited.

In an example embodiment, an N point IFFT is shown at equation (3):

$$x [ n ] = {\sum }_{i = 0}^{N - 1} X [ i ] {e}^{j \frac{2 π in}{N}} - \qquad ( 3 )$$

where,

### N represents number of sub-carriers in a block;

n represents the time index; and
i represents the sub-carrier index.
If N″=N/Q, the N′ point FFT is as follows:

$$x [ n ] = {\sum }_{m = 0}^{m = Q - 1} {e}^{j \frac{2 π nm}{N}} {\sum }_{i = 0}^{\frac{N}{Q} - 1} X [ iQ + m ] {e}^{j \frac{2 π in}{N / Q}} - \qquad ( 4 )$$

Since, X[iQ+m] is non-zero for only one value of m (as X comprises non-zero values only at pilot locations and zeros elsewhere), equation (4) can further be simplified to:

$$x [ n ] = {e}^{j \frac{π {nm}_{nonzero}}{N}} {\sum }_{i = 0}^{\frac{N}{Q} - 1} X [ iQ + {m}_{nonzero} ] {e}^{j \frac{2 π in}{N / Q}} - \qquad ( 5 )$$

The value of m_{nonzero} is such that X[iQ+m_{nonzero}] gives values of X at each pilot location. In an embodiment, if the location of the first pilot in a set of equi-spaced pilots is at ‘L₁’ (including left guard carriers), m_{nonzero}=mod(L₁, Q). As a result of equation (5), the number of complex multiples required is given by:

$${N}_{cmplx\_mults} = \frac{N}{p} [ log ( \frac{N}{p} ) + 1 ] - \qquad ( 6 )$$

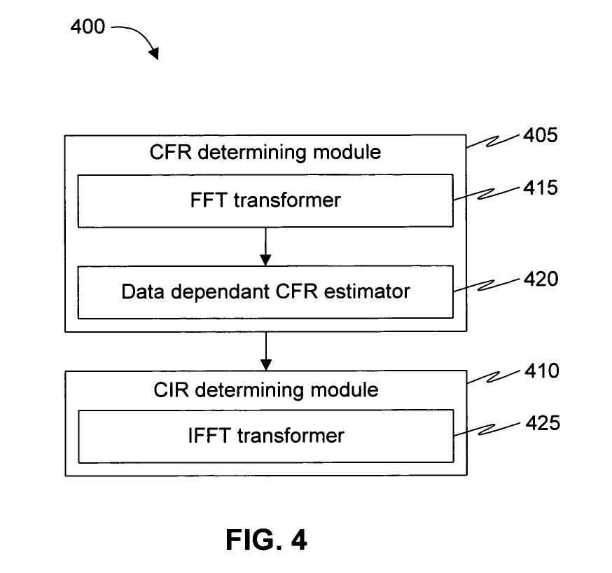

FIG. 4 is a block diagram of a receiver 400 of a block transmission system, in accordance with an embodiment. Receiver 400 operates according to the operations described above with reference to FIG. 1, FIG. 2, and FIG. 3 but is not so limited. Receiver 400 includes a CFR determining module 405 coupled to a CIR determining module 410. In an embodiment, the block transmission is a Multiple input Multiple Output (MIMO) block transmission system but is not so limited.

CFR determining module 405 is configured to determine the CFR in a block transmission system. CFR determining module includes but is not limited to a FFT transformer 415 and a data dependent CFR estimator 420. FFT transformer 415 is configured to perform an N′ point FFT. In various embodiments, N′ is a function of N and K, where N is approximately equal to the number of sub-carriers in a block, and K depends on the coherence bandwidth of the channel corresponding to the block. In an embodiment, N′ is equal to ratio of N and K. In an example embodiment, N′ is equal to N/K.

In an embodiment, the CFR is estimated for each Kth sub-carrier index. Data dependant CFR estimator 420 is configured to estimate the CFR corresponding to each remaining data sub-carrier by interpolating a plurality of CFRs corresponding to adjacent Kth sub-carriers. As a result, the interpolation is not performed for remaining sub-carriers on which, for example, pilot tones are transmitted. In various embodiments, the sub-carrier index of each remaining data sub-carrier is unequal to an integral multiple of K.

CIR determining module 410 is configured to determine the CIR in a block transmission system. CIR determining module 410 includes an IFFT transformer 425 but is not so limited. IFFT transformer 425 is configured to perform an N″ point IFFT, where N″ is a function of N and P.

In various embodiments, N″ is a function of N and P, where N is approximately equal to the number of sub-carriers in a block, and P is approximately equal to the pilot sub-carrier spacing. In an embodiment, N″ is approximately equal to ratio of N and Q, where Q is a common divisor of N and P. In an example embodiment, N″ is approximately equal to N/Q but is not so limited. In an embodiment, Q is an integral power of two but is not so limited.

In an embodiment, receiver 400 is implemented on a subscriber station. In another embodiment, receiver 400 is implemented on a base station of the block transmission system.

The various embodiments described above provide a method and system for computationally efficient estimation of channel response in a block transmission system. Further, when computing the CFR from the CIR, the frequency domain interpolator (which works in tandem with the low complexity FFT), can also mitigate band-edge effects, and therefore, improve channel estimation quality.

What is claimed is:

1. A method for determining a channel frequency response (CFR) of a plurality of data symbols in a block transmission system, the method comprising performing an N′ point Fast Fourier Transformation (FFT), wherein N′ is a function of N and K, wherein N is approximately equal to the number of sub-carriers in a block, and K depends on the coherence bandwidth of the channel corresponding to the block.

2. The method of claim 1, wherein N′ is approximately equal to a ratio of N and K.

3. The method of claim 1, wherein K is an integral power of two.

4. The method of claim 1, further comprising estimating a CFR for each Kth sub-carrier index.

5. The method of claim 4, further comprising estimating a CFR of each remaining data sub-carrier by interpolating a plurality of estimated CFRs of adjacent Kth sub-carriers, the adjacent Kth sub-carriers being adjacent to the corresponding remaining data sub-carriers, wherein the sub-carrier index of each remaining data sub-carrier is unequal to an integral multiple of K.

6. The method of claim 5, wherein K depends on the complexity of the interpolation.

7. The method of claim 5, wherein order of interpolation is modified to handle band-edge effects of a block.

8. A method for determining a channel impulse response (CIR) of a plurality of data symbols in a block transmission system, the method comprising:
a. receiving the plurality of data symbols; and
b. performing an N″ point Inverse Fast Fourier Transformation (IFFT), wherein N″ is a function of N and P, wherein N is approximately equal to the number of sub-carriers in a block, and P is approximately equal to the pilot sub-carrier spacing.

9. The method of claim 8, wherein N″ is approximately equal to a ratio of N and Q, wherein Q is a common divisor of N and P.

10. The method of claim 8, wherein Q is an integral power of two.

11. A receiver of a block transmission system, the receiver comprising a channel frequency response (CFR) determining module, the CFR determining module configured to determine a CFR of a plurality of data symbols, wherein the CFR determining module comprises:
a. a Fast Fourier Transformation (FFT) transformer, the FFT transformer configured to perform a N′ point FFT, wherein N′ is a function of N and K, wherein N is approximately equal to the number of sub-carriers in a block, and K depends on the coherence bandwidth the channel corresponding to the block.

12. The receiver of claim 11, wherein N′ is approximately equal to a ratio of N and K.

13. The receiver of claim 11, wherein K is an integral power of two.

14. The receiver of claim 11, wherein a CFR is estimated for each Kth sub-carrier index.

15. The receiver of claim 11, wherein the CFR determining module comprises a data dependent CFR estimator coupled to the FFT transformer, the data dependent CFR estimator configured to estimate a CFR of each remaining data sub-carrier by interpolating a plurality of estimated channel frequency responses of adjacent Kth sub-carriers, the adjacent Kth sub-carriers being adjacent to the corresponding remaining data sub-carriers, wherein the sub-carrier index of each remaining data sub-carrier is unequal to an integral multiple of K.

16. The receiver of claim 15, wherein K depends on the complexity of the interpolation.

17. The receiver of claim 15, wherein the data dependent CFR estimator is configured to modify an order of the interpolation according to band-edge effects of the block.

18. The receiver of claim 11, further comprising a channel impulse response (CIR) determining module coupled to the CFR determining module, the CIR determining module configured to determine a CIR, wherein the CIR determining module comprises:
a. an Inverse Fast Fourier Transformation (IFFT) transformer, the IFFT transformer configured to perform a N″ point IFFT, wherein N″ is a function of N and P, wherein P is approximately equal to the pilot sub-carrier spacing.

19. The receiver of claim 18, wherein N″ is approximately equal to a ratio of N and Q, wherein Q is a common divisor of N and P.

20. The receiver of claim 19, wherein Q is an integral power of two.
